(19) United States
(12) Patent Application Publication
(10) Pub. No.: US 2009/0244463 A1
(43) Pub. Date: Oct. 1, 2009

(54) LIQUID CRYSTAL DISPLAY PANEL

(75) Inventor: I-Fang Wang, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/408,724

(22) Filed: Mar. 23, 2009

(30) Foreign Application Priority Data
Mar. 27, 2008 (TW) 97111016

(51) Int. Cl. G02F 1/1337

(52) U.S. Cl. 349/129

(57) ABSTRACT

An LCD panel includes a first polarizer, a second polarizer, an active device array substrate, an opposite substrate, a plurality of alignment structures and a liquid crystal layer. The first polarizer has a first absorption axis. The active device array substrate has a plurality of pixel regions. The alignment structures are disposed on a side of the active device array substrate adjacent to the opposite substrate or on a side of the opposite substrate adjacent to the active device array substrate, and respectively correspond to the pixel regions. Within each of the pixel region, a first included angle between an extending direction of a part of the alignment structures and the first absorption axis is not equal to a second included angle between an extending direction of another part of the alignment structures and the first absorption axis.

### CROSS-REFERENCE TO RELATED APPLICATION

This application claims the priority benefit of Taiwan application serial no. 97111016, filed on Mar. 27, 2008. The entirety of the above-mentioned patent application is hereby incorporated by reference herein and made a part of specification.

### BACKGROUND OF THE INVENTION

1. Field of the Invention

The present invention generally relates to a liquid crystal display panel (LCD panel), and more particularly, to a multi-domain vertically alignment (MVA) LCD panel.

2. Description of Related Art

A liquid crystal display (LCD) is advantageous in high display quality, small size, light weight, low driving voltage, low power consumption and wide application spectrums, so that the LCD today has almost substituted cathode ray tubes (CRTs) and have played a major role in the mainstream display market.

Currently, the performance demand from the market on an LCD mainly focuses on high contrast ratio, fast response and wide-viewing angle. In this regard, the MVA LCD is considered as one of various LCD types in common use and able to reach the wide-viewing-angle demand today.

Although an MVA LCD in the prior art today can meet the requirement of wide-viewing-angle, however, as a user watches the MVA LCD in a larger angle of viewing, the seen image often has a flaw of color washout, i.e., a color shift phenomenon.

In order to lighten the above-mentioned color shift phenomenon, there is a solution provided by the prior art that an MVA LCD employs a pixel structure having at least two transmittances, which is explained as follows.

First, a pixel region is divided into two or more sub-pixel regions having different liquid crystal capacitors through design and process. By means of a capacitance coupling effect, voltage differences of the liquid crystal capacitors in the two sub-pixel regions are different, so as to enable the liquid crystal molecules within the two sub-pixel regions respectively to have different inclination extents. At this time, the sub-pixel regions have different transmittances, wherein one sub-pixel region with a higher transmittance displays an image in a higher graylevel, and another sub-pixel region with a lower transmittance displays an image in a lower graylevel. The image with a lower graylevel and the image with a higher graylevel are blended into an image with a middle graylevel, so that a user is allowed to watch the above-described LCD in any angle of viewing to see images in nearly the same graylevel and uninfluenced by the angle of viewing.

Note that although the above-mentioned pixel structure is able to lighten the color shift phenomenon, but the pixel structure increases the structure complexity, which causes the pixel structure having not only a difficult layout, but also a lower aperture ratio. Therefore, the transmittance of the LCD is lower. In addition, the above-described LCD likely produces an image sticking flaw as well.

### SUMMARY OF THE INVENTION

Accordingly, the present invention is directed to an LCD panel capable of lightening the color shift phenomenon without decreasing the aperture ratio.

The present invention provides an LCD panel, which includes a first polarizer, a second polarizer, an active device array substrate, an opposite substrate, a plurality of first alignment structures and a liquid crystal layer. The first polarizer has a first absorption axis, and the second polarizer is disposed opposite to the first polarizer. The active device array substrate has a plurality of pixel regions, which is disposed opposite to the opposite substrate and together with the opposite substrate disposed between the first polarizer and the second polarizer. The first alignment structures are disposed on a side of the active device array substrate facing the opposite substrate or on a side of the opposite substrate facing the active device array substrate. The first alignment structures respectively correspond to the pixel regions. Within each of the pixel region, a first included angle between an extending direction of a part of the first alignment structures and the first absorption axis is not equal to a second included angle between an extending direction of another part of the first alignment structures and the first absorption axis. The liquid crystal layer is disposed between the active device array substrate and the opposite substrate.

In an embodiment of the present invention, a sum of the above-mentioned first included angle and second included angle is greater than or equal to 80 angle degree but smaller than or equal to 110 angle degree.

In an embodiment of the present invention, the above-mentioned first included angle is greater than or equal to 35 angle degree but smaller than or equal to 55 angle degree.

In an embodiment of the present invention, the above-mentioned second included angle is greater than or equal to 35 angle degree but smaller than or equal to 55 angle degree.

In an embodiment of the present invention, the above-mentioned first alignment structures comprise alignment protrusions, alignment slits or a combination thereof.

In an embodiment of the present invention, the above-mentioned active device array substrate comprises a plurality of pixel electrodes respectively disposed within the pixel regions, and the above-mentioned opposite substrate comprise a common electrode.

In an embodiment of the present invention, the above-mentioned first alignment structures are disposed on the common electrode or respectively disposed on the pixel electrodes.

In an embodiment of the present invention, the above-mentioned LCD panel further comprises a plurality of second alignment structures parallel to the first alignment structures and staggered by the first alignment structures, wherein the first alignment structures are disposed on the common electrode and the second alignment structures are respectively disposed on the pixel electrodes.

In an embodiment of the present invention, the above-mentioned first alignment structures and the above-mentioned second alignment structures respectively comprise alignment protrusions and/or alignment slits.

In an embodiment of the present invention, the above-mentioned second polarizer comprises a second absorption axis, and the first absorption axis is perpendicular to the second absorption axis.

The present invention is capable of lightening the color shift phenomenon of the LCD by adjusting the included angles between the extending directions of the alignment structures and the absorption axes.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure diagram of an LCD panel according to an embodiment of the present invention.

FIG. 2 is a top-view diagram of the LCD panel as shown in FIG. 1.

FIGS. 3A-3D are graphs showing the relationships between the color coordinate values and the tilt angles of a conventional LCD and an LCD of the present invention correspondingly to different orientation angles.

FIG. 4 is a top-view diagram of an LCD panel according to another embodiment of the present invention.

FIG. 5 is a cross-sectional diagram along the line I-I as shown in FIG. 4.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

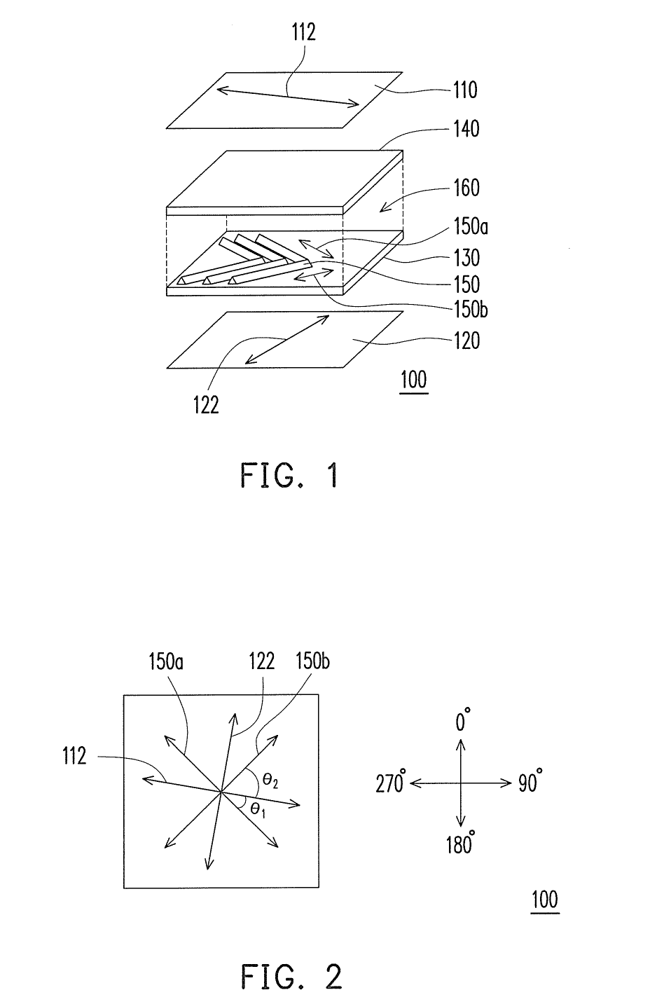

FIG. 1 is a structure diagram of an LCD panel according to an embodiment of the present invention and FIG. 2 is a top-view diagram of the LCD panel as shown in FIG. 1. Referring to FIGS. 1 and 2, the LCD panel 100 includes a first polarizer 110, a second polarizer 120, an active device array substrate 130, an opposite substrate 140, a plurality of alignment structures 150 and a liquid crystal layer 160. The first polarizer 110 has a first absorption axis 112, and the second polarizer 120 is disposed opposite to the first polarizer 110 and has a second absorption axis 122, wherein the first absorption axis 112 is, for example, perpendicular to the second absorption axis 122. The active device array substrate 130 is disposed opposite to the opposite substrate 140 and together with the opposite substrate 140 disposed between the first polarizer 110 and the second polarizer 120. In addition, the liquid crystal layer 160 is disposed between the active device array substrate 130 and the opposite substrate 140.

The active device array substrate 130 has a plurality of pixel regions (not shown) and a plurality of pixel electrodes (not shown). The pixel electrodes are disposed on a side surface of the active device array substrate 130 facing the opposite substrate 140 and respectively corresponding to the pixel regions. The opposite substrate 140 has a common electrode (not shown) disposed on a side surface of the opposite substrate 140 facing the active device array substrate 130. For the purpose of illustration of the present embodiment, only one of the pixel regions of the active device array substrate 130 is shown in FIGS. 1 and 2, but the pixel electrode, the common electrode and the active devices disposed on the active device array substrate 130 are omitted.

In the present embodiment, the alignment structures 150 are, for example, a plurality of alignment protrusions respectively disposed on the pixel electrodes and respectively correspond to the pixel regions; however in other un-shown embodiments, the alignment structures 150 can be a plurality of alignment slits or composed of a plurality of alignment protrusions and a plurality of alignment slits, wherein the alignment slits are staggered by the alignment protrusions. Besides, the alignment structures 150 can not only respectively disposed on the pixel electrodes, but also on the common electrode.

A first included angle θ₁ is formed between an extending direction 150a of a part of the alignment structures 150 and the first absorption axis 112, and a second included angle θ₂ is formed between an extending direction 150b of another part of the alignment structures 150 and the first absorption axis 112, wherein the first included angle θ₁ is not equal to the second included angle θ₂.

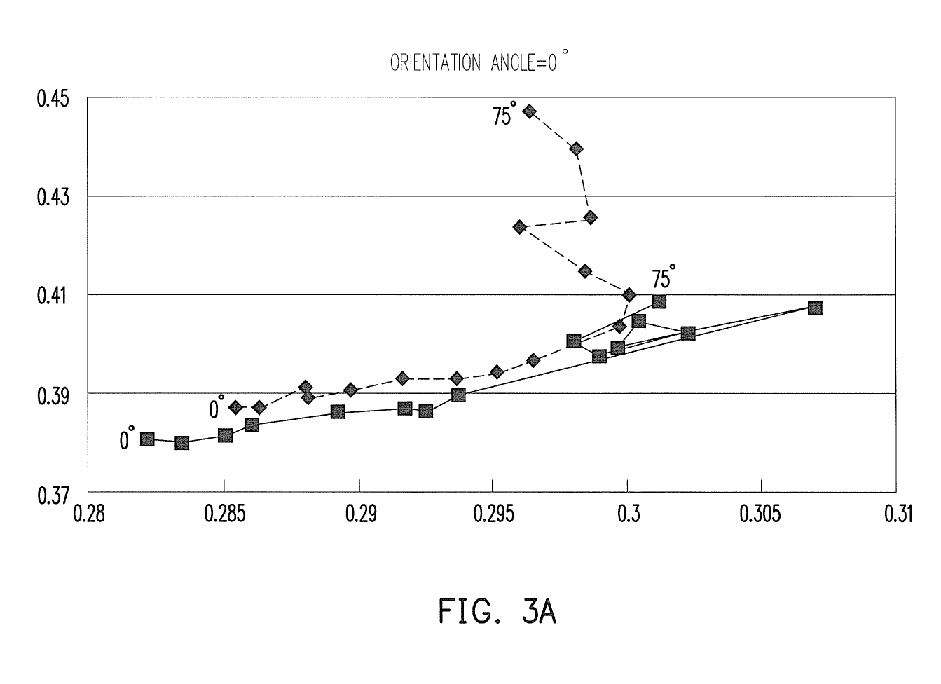

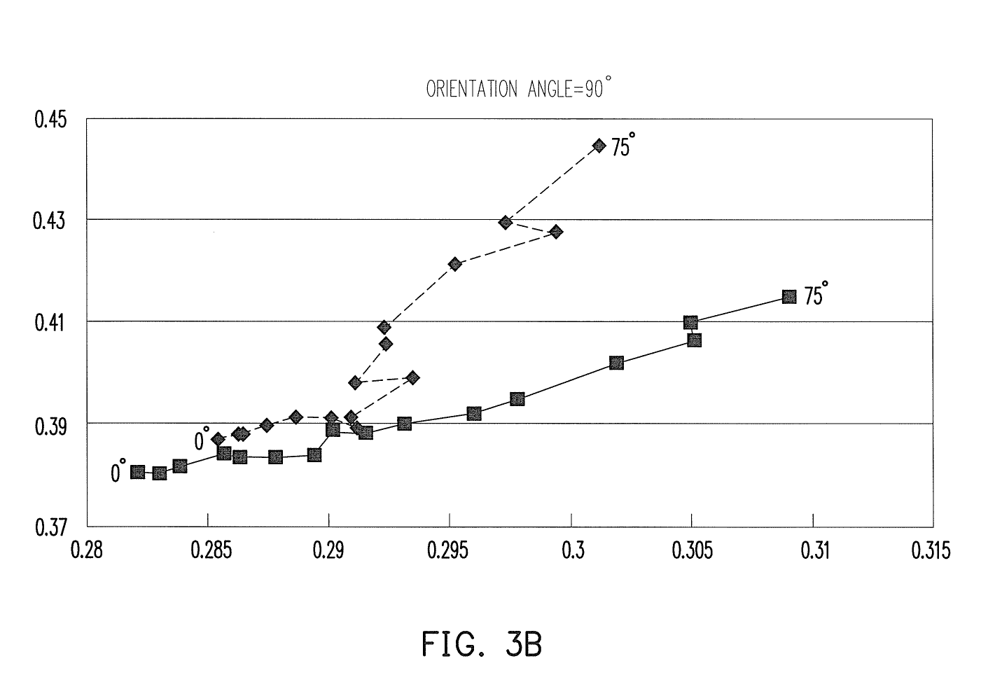

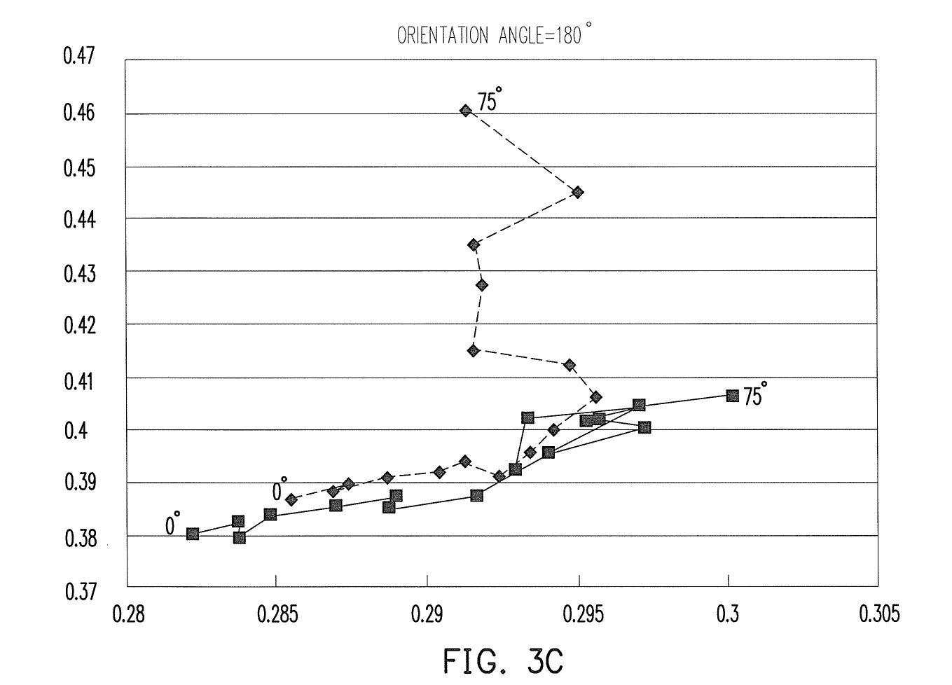

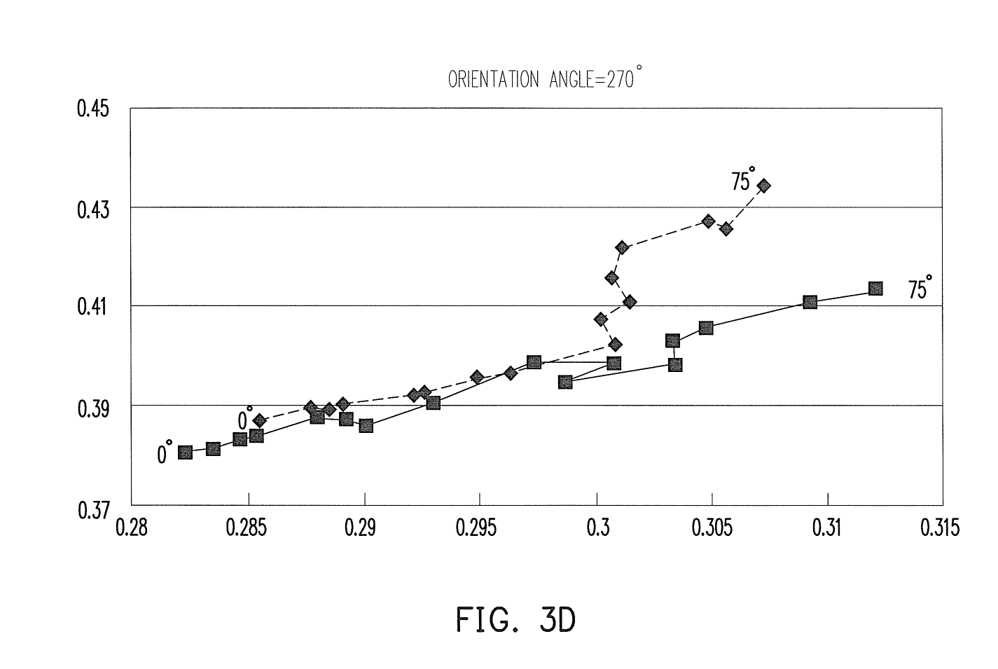

FIGS. 3A-3D are graphs showing the relationships between the color coordinate values and the tilt angles of a conventional LCD and an LCD of the present invention correspondingly to different orientation angles, wherein FIGS. 3A-3D are respectively corresponding to orientation angles of 0°, 90°, 180° and 270°, and the four angle degrees correspond to the orientation angles of 0°-270° shown in FIG. 2. Note that the tilt angles of the color coordinate values in FIGS. 3A-3D ranges between 0° and 75° and take a plurality of orientation angles spaced in 5° between any two adjacent ones, wherein the tilt angle perpendicular to the active device array substrate 130 is defined as 0° and the tilt angle parallel to the active device array substrate 130 is defined as 90°.

The broken lines in FIGS. 3A-3D represent the relationships between the color coordinate values and the tilt angles of a conventional LCD, wherein the orientation angle of the first absorption axis 112 is 90°, the orientation angle of the second absorption axis 122 is 0°, the extending directions 150a and 150b of the alignment structures 150 are respectively 135° and 45°. Besides, both the first included angle θ₁ and the second included angle θ₂ are 45°. The solid lines in FIGS. 3A-3D represent the relationships between the color coordinate values and the tilt angles of an LCD provided by the present embodiment, wherein the orientation angle of the first absorption axis 112 is 92°, the orientation angle of the second absorption axis 122 is 2°, the extending directions 150a and 150b of the alignment structures 150 are respectively 135° and 45°. Besides, the first included angle θ₁ and the second included angle θ₂ are respectively 43° and 47°.

It can be seen from FIGS. 3A-3D, in terms of the conventional LCD (represented by the broken lines), the greater the tilt angle, the more obvious the color shift phenomenon produced by an image is. In contrast, in terms of the LCD of the present invention, (represented by the solid lines), for greater tilt angles the same as the one of the conventional LCD, the color shifts produced by an image of the LCD of the present invention have a less amplitudes than the ones of the conventional LCD. In particular, if the first included angle θ₁ is not equal to the second included angle θ₂, the color shift phenomenon of an image is significantly lightened.

In the present embodiment, a sum of the first included angle θ₁ and the second included angle θ₂ is preferably, for example, greater than or equal to 80 angle degree but smaller than or equal to 110 angle degree. Furthermore, the first included angle θ₁ is preferably, for example, greater than or equal to 35 angle degree but smaller than or equal to 55 angle degree; the second included angle θ₂ is preferably, for example, greater than or equal to 35 angle degree but smaller than or equal to 55 angle degree.

Note that the scheme the above-mentioned embodiment adopts is, for example, adjusting the orientation angles of the first absorption axis 112 and the second absorption axis 122 and keeping the extending directions 150a and 150b of the alignment structures 150 unchanged. However, the present invention can adopt another scheme of keeping the orientation angles of the first absorption axis 112 and the second absorption axis 122 unchanged and adjusting the extending directions 150a and 150b of the alignment structures 150.

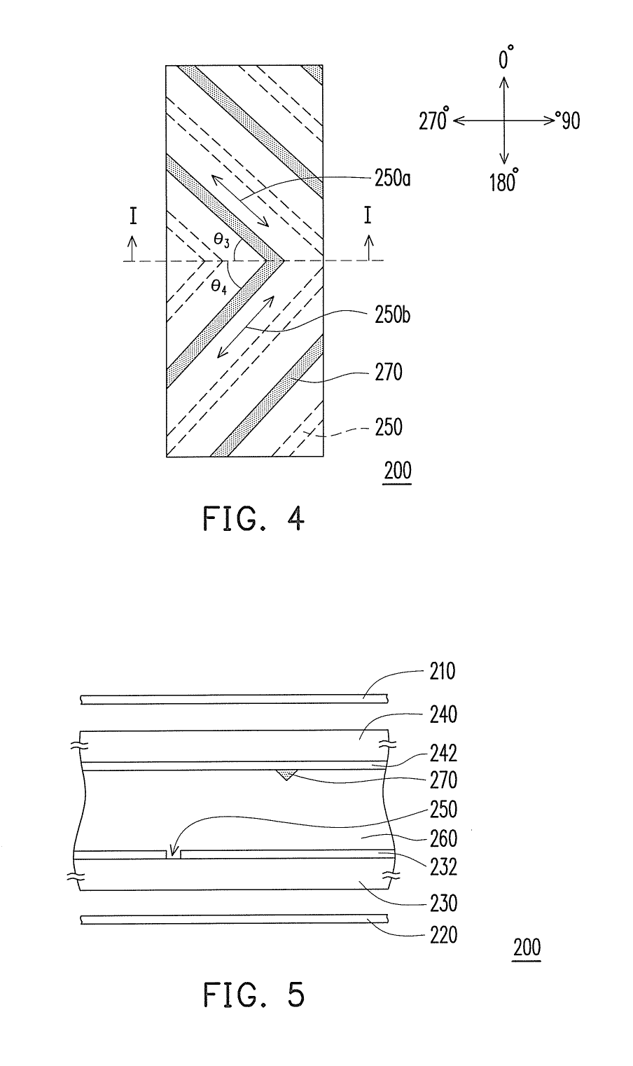

FIG. 4 is a top-view diagram of an LCD panel according to another embodiment of the present invention and FIG. 5 is a cross-sectional diagram along the line I-I as shown in FIG. 4. Referring to FIGS. 4 and 5, the LCD panel 200 includes a first polarizer 210, a second polarizer 220, an active device array substrate 230, an opposite substrate 240, a plurality of first alignment structures 250 and a liquid crystal layer 260. For the purpose of illustration of the present embodiment, only one of the pixel regions of the active device array substrate 230 is shown in FIGS. 4 and 5, but the active devices disposed on the active device array substrate 230 are omitted. In addition, the first polarizer 210 and the second polarizer 220 are also omitted to more clearly illustrate the detail structure of the first alignment structures 250 and the extending direction 250a and 250b thereof.

In the present embodiment, the structures and the relative positions of the first polarizer 210, the second polarizer 220, the active device array substrate 230, the opposite substrate 240, the first alignment structures 250 and the liquid crystal layer 260 are similar to that of the previous embodiment except that the orientation angle of a first absorption axis (not shown) of the first polarizer 210 is 90°, the orientation angle of a second absorption axis (not shown) of the second polarizer 220 is 0°, and the orientation angles of the extending direction 250a and 250b of the first alignment structures 250 are respectively 133° and 43°. In this way, a third included angle θ₃ between the extending direction 250a of the first alignment structures 250 and the first absorption axis would be 43°, and a fourth included angle θ₄ between the extending direction 250b of the first alignment structures 250 and the first absorption axis would be 47°, where the third included angle θ₃ is not equal to the fourth included angle θ₄, so that the color shift phenomenon of an image can be effectively lightened.

Similar to the previous embodiment, a sum of the third included angle θ₃ and the fourth included angle θ₄ is preferably, for example, greater than or equal to 80 angle degree but smaller than or equal to 110 angle degree. Furthermore, the third included angle θ₃ is preferably, for example, greater than or equal to 35 angle degree but smaller than or equal to 55 angle degree; the fourth included angle θ₄ is preferably, for example, greater than or equal to 35 angle degree but smaller than or equal to 55 angle degree.

In the present embodiment, the LCD panel 200 can include a plurality of second alignment structures 270 parallel to and staggered by the first alignment structures 250. The first alignment structures 250 herein are, for example, a plurality of alignment slits respectively disposed on a plurality of pixel electrodes 232 of the active device array substrate 230, and the second alignment structures 270 herein are, for example, a plurality of alignment protrusions disposed on a common electrode 242 of the opposite substrate 240.

The above-described embodiment is not intended to limit the present invention. In other un-shown embodiments, the first alignment structures 250 can be a plurality of alignment protrusions or composed of a plurality of alignment protrusions and a plurality of alignment slits staggered by the alignment protrusions. In addition, the second alignment structures 270 can be a plurality of alignment slits or composed of a plurality of alignment protrusions and a plurality of alignment slits staggered by the alignment protrusions.

In summary, compared to the prior art, the present invention adopts a scheme of adjusting the included angle between the extending direction of the alignment structures and the absorption axis and the color shift phenomenon of an image is thereby significantly lightened. In short, the present invention is advantageous in high feasibility in practice, simple structure, layout friendly, high aperture ratio and high transmittance.

The above described are preferred embodiments of the present invention only, which do not limit the implementation scope of the present invention. It will be apparent to those skilled in the art that various modifications and equivalent variations can be made to the structure of the present invention without departing from the scope or spirit of the invention.

What is claimed is:

1. A liquid crystal display panel, comprising:
a first polarizer, having a first absorption axis;
a second polarizer, disposed opposite to the first polarizer;
an active device array substrate, disposed between the first polarizer and the second polarizer and comprising a plurality of pixel regions;
an opposite substrate, disposed between the first polarizer and the second polarizer and opposite to the active device array substrate;
a plurality of first alignment structures, disposed on a side of the active device array substrate facing the opposite substrate or on a side of the opposite substrate facing the active device array substrate, and respectively correspond to the pixel regions, wherein within each of the pixel region, a first included angle between an extending direction of a part of the first alignment structures and the first absorption axis is not equal to a second included angle between an extending direction of another part of the first alignment structures and the first absorption axis; and
a liquid crystal layer, disposed between the active device array substrate and the opposite substrate.

2. The liquid crystal display panel according to claim 1, wherein a sum of the first included angle and the second included angle is greater than or equal to 80 angle degree but smaller than or equal to 110 angle degree.

3. The liquid crystal display panel according to claim 1, wherein the first included angle is greater than or equal to 35 angle degree but smaller than or equal to 55 angle degree.

4. The liquid crystal display panel according to claim 1, wherein the second included angle is greater than or equal to 35 angle degree but smaller than or equal to 55 angle degree.

5. The liquid crystal display panel according to claim 1, wherein the first alignment structures comprise alignment protrusions, alignment slits or a combination thereof.

6. The liquid crystal display panel according to claim 1, wherein the active device array substrate comprises a plurality of pixel electrodes respectively disposed within the pixel regions, and the opposite substrate comprises a common electrode on a side of the opposite substrate facing the active device array substrate.

7. The liquid crystal display panel according to claim 6, wherein the first alignment structures are disposed on the common electrode or respectively disposed on the pixel electrodes.

8. The liquid crystal display panel according to claim 6, further comprising a plurality of second alignment structures parallel to the first alignment structures and staggered by the first alignment structures, wherein the first alignment structures are disposed on the common electrode and the second alignment structures are respectively disposed on the pixel electrodes.

9. The liquid crystal display panel according to claim 8, wherein the first alignment structures and the second alignment structures respectively comprise alignment protrusions, alignment slits or a combination thereof.

10. The liquid crystal display panel according to claim 1, wherein the second polarizer comprises a second absorption axis, and the first absorption axis is perpendicular to the second absorption axis.
